(19) United States
(12) Patent Application Publication
(10) Pub. No.: US 2010/0044494 A1
(43) Pub. Date: Feb. 25, 2010

(54) Space launcher

(76) Inventor: George A. Teacherson, Royal Palm Beach, FL (US)

Correspondence Address: George Teacherson, 103 Conaskonk Circle, Royal Palm Beach, FL, 33411, US

(21) Appl. No.: 12/386,455

(22) Filed: Apr. 17, 2009

Related U.S. Application Data
(60) Provisional application No. 61/124,575, filed on Apr. 17, 2008.

(51) Int. Cl. B64C 37/02; B64G 1/40; B64G 1/00; B64G 1/58; B64G 1/62

(52) U.S. Cl. 244/2; 244/171.3; 244/159.1

(57) ABSTRACT

A space vehicle and its launcher are capable of low-cost launch, safe maneuvering, plus powered go-around for landing.

This application claims the benefit of the earlier filing date of the provisional patent application Ser. No. 61/124,575, filed Apr. 17, 2008 by the instant inventor.

### FIELD OF THE INVENTION

This invention relates to launchers of space vehicles and more particularly to simplified, low-cost space launchers.

### BACKGROUND OF THE INVENTION

The cheapest present way to launch a payload into space is via winged vehicles first and then rockets beginning at altitude.

Winged vehicles normally use air-breathing engines for their propulsion. Since the ambient atmosphere provides oxygen for propulsion, using this configuration obviates the need for carrying the weight of oxidizer and consequently paying the cost of lifting oxidizer and thus necessarily and additionally a bigger and heavier structure is saved.

The Burt Rutan designed SpaceShipOne is a good modern example. There is a winged carrier that lifts the SpaceShipOne vehicle to 40,000 feet of altitude and then lets it go. The carrier has a massive wingspan. SpaceShipOne itself has a short delta wing on a pivot. It is rocket powered. At its maximum altitude, its wing pivots to 90-degrees so to form a massive drag. The drag slows down the vehicle enough to obviate any need of ablative or other types of heat shield. Thus it makes for a relatively inexpensive space launch and recovery.

The instant invention, contrarily, provides a space traveling vehicle with a plurality of wings so to lift its own weight. The wings are set firmly within a structure. Each is set in staggerwing fashion behind the front one. But the flat face they together produce when the whole vehicle is turned 90-degrees to the slipstream forms a huge drag producing “wall”. This massive drag-producing wall slows down the vehicle without the need for a heat shield. It also obviates the need for heavy pivots and complicated controls. Also in the instant design, since the space vehicle itself has a wing area sufficient to lift itself, at minimum, the instant carrier need not lift dead weight and may be designed to lift only itself and be provided with just enough power to propel the entire stack to altitude where it releases the space vehicle. The carrier itself now has absolutely minimum weight. Its wingspan is now also smaller than a prior art carrier.

Thus the entire instant space launcher stack can be built even more cheaply than the existing Rutan design. Plus, with the addition of refractory inflatable materials such as the Goodyear designed Airmat, heavy heat shielding will not even be necessary for higher, faster altitudes than the simple low ballistic trajectories. There is also an intumescent paint called Chartec that protects against 5,000 degrees of heat. This also obviates the need for prior art expensive and complicated heat shielding.

It is an object of the instant invention to provide a low cost space launcher.

### BRIEF DESCRIPTION OF THE DRAWING

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. The several figures of the drawing, in which like designations denote like elements, are representative only and do not appear as limiting in any way.

FIG. 1 is a side view of a multi-winged space vehicle

FIG. 2 is a top view of the high speed, multi winged space vehicle of FIG. 1 having foldable and telescoping wings.

FIG. 3 is a side view of a multi winged space vehicle carrier vehicle.

FIG. 4 is a side view of refractory inflatable material protecting the vehicle of FIG. 1 during reentry.

FIG. 5 is a cutaway view of the inside of a fuel tank.

FIG. 6 is a side view of a thin wing grouping.

### DESCRIPTION OF THE PREFERRED EMBODIMENT

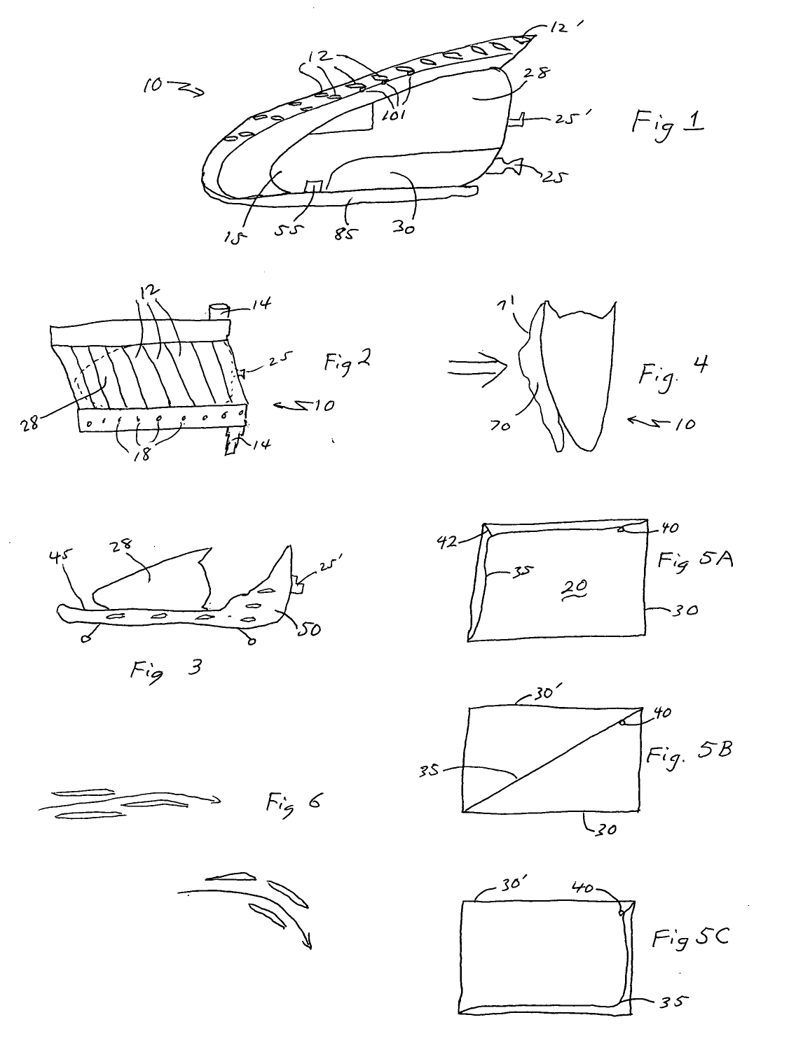

Turning to FIG. 1, space vehicle 10 is shown with a plurality of wings 12 arranged in ascending position as they are positioned farther back from the nose 15. Wings 12 can be arranged in up-down fashion behind one another as shown in the front of vehicle 10. Or they may be arranged simply behind one another as shown towards the rear of vehicle 10. Other wing placement variations may be allowed. Wings 12 would preferably be mounted upon structural ties 85. Ties 85 could extend from the bottom of vehicle 10 where it supports the cabin 28 and tank 30 structure(s) to the wings 12 wingtips where it provides structural support to the tips. The cab 28 and fuel tank 30 of the vehicle 10 can use ties 85 as a solid structural mounting. Thus, ties 85 can be a “backbone” of the entire invention 10. Wings 12 can have Magnus rotors 101 to significantly increase their lift.

It should be immediately noted that instant space vehicle 10 can in fact be put together in two pieces. The cab 28 and its air-breathing engine 25′ with fuel tank 30 and/or 30′ can be an air-breathing atmosphere flying vehicle. The second piece may be attached as needed or at will specifically for turning vehicle 10 from a strictly atmospheric vehicle 10 into instant space vehicle 10. Rocket engine 25 and rocket fuel tank 30 may together form the second piece of invention 10. Split into two pieces, invention 10 need not carry around the extra weight of rocket engine 25 nor rocket fuel tank(s) 30 if it is being used solely for air travel. When needed or desired for space travel, the upper piece of invention 10 then preferably removably hooks onto the lower piece of invention 10 thus forming space vehicle 10. Hence, ties 85 can be used here as a “drawer” into which the second piece is slid. Or the second piece may be removably attached underneath ties 85. In this way, ties 85 still form a backbone for the entire space vehicle 10 whether or not it is fitted out for space travel.

With the use of separating bladder 35, fuel tank 30/30′ can be one unit always on vehicle 10. When used for air travel, fuel tank 30′ can carry only air travel engine fuel. When used for air/space travel, then fuel tank 30 can be filled with rocket fuel 20 and vehicle 10 may be placed aboard carrier vehicle 50 for space launch. Physically, tank 30/30′ can be the same exterior enclosure but with capability for handling two differing fuels within its interior. See FIG. 5. Or, tank 30 may be added along with rocket engine 25 to separately provide rocket capability. Here, tank 30′ and air travel engine 25′ can provide useful go-around capability for space vehicle 10 upon re-entry and landing.

Wings 12 can be either straight wings, FIG. 1, for use in a flying car type vehicle 10 or a low speed UAV or observation or pleasure aircraft 10. Or as shown in FIG. 2, they may be swept back for high-speed flight. 45-degree sweep is shown. In a vehicle 10 that is designed to be capable of both low-speed and high speed flight, structural ties 85 may be slidably attached to one side of wings 12. The sliding action would be activated via suitable well known prior art actuators. For low speed flight, ties 85 would hold wings 12 in straight position to the atmospheric airflow. For high speed flight or for flight that is increasing from low to high speed, one side of ties 85 on the top of invention 10 would slide towards the rear of vehicle 10. Variable sweep may be accomplished via sliding ties 85 forwards toward the nose of vehicle 10. Sliding ties 85 would preferably be attached to wings 12 via pivots 18 on the sliding side of ties 85. Thus, as ties 85 slide back along vehicle 10, wings 12 go from the straight wing position of FIG. 1 to the swept wing position of FIG. 2. Or sliding may go in the forward direction. Hence, it is seen that invention 10 can cover a type of high speed vehicle 10, low speed vehicles 10 or a type of vehicle 10 that can be redesigned in flight to be fully and efficiently operable in both speed regimes. Note that instant sliding ties 85 is a simpler, easier and lighter in weight solution to the prior art's military pivoting wing box method of sweeping wings for differing flight regimes. Use of multiple wings 12 along with sliding ties 85 and lighter in weight pivots 18 allow military aircraft 10 to be fully efficient and fully maneuverable throughout their entire flight envelope. For military aircraft or other designs, there is no requirement that wings 12 need be mounted directly atop the vehicle 10 as shown herein.

Note also that for wings 12 mounted in the normal fashion of sticking out of fuselage 28 or cab 28, a trailing wing 12 could be used as a mounting “rail” for sliding ties 85. Ties 85 can simply slide back with wings 12 on pivots. It is simple and “redesigns” vehicle 10 for low to high speed flight very quickly. Thus, the instant design can very well take vehicle 10 from a residence garage to high speed flight to space travel as is disclosed herein. Piston, jet, fluid-powered flight and rocket flight can be hybridized.

Additionally, outrigger wings 14 that can fold back (right side of vehicle) or telescope (left side, FIG. 2) to add additional lifting-wing/reentry-drag area as needed or desired can be provided to chosen ones or all of wings 12.

Outrigger wings 14 can be full chord, standard, known wings if necessary for flutter mitigation. However, wings 14 may also be short-chord, as are shown for wings 12. Note again that in the instant configuration, wings 12 are shown tied to an outside structural member 85 at their tips. Thus, flutter should not be a problem for wings 12. Outrigger wings 14 could be of Airmat type construction for inflation upon re-entry. Airmat was designed for, among other things, space/rocket fin applications. Such wings would be stowed within the wingtip structure 16 of wings 12 or ties 85 until needed and then instantly inflated as Airmat capability has already been originally designed for and well shown in the literature and in audio-video demonstrations.

Further, “instant” inflation has already been shown in well known airbags as well.

During re-entry, vehicle 10 would maneuver 90 degrees to the passing atmospheric airflow. See airflow double arrow in FIG. 4. With proper placement of the grouping of wings 12, the grouping would then present an ultra-high-drag “wall” planform so to slow down vehicle 10 for landing. Since wings 12 are preferably set in ascending positions towards the back of vehicle 10, the pilot in the cabin 28 can see straight through the grouping of wings 12 for piloting purposes. Known actuators can also “bunch” the wings 12 in operating positions that keep the pilot's vision perfectly clear and then during re-entry, move them into protecting position as shown in FIG. 1.

During re-entry of vehicle 10, designated ones 12′ of said wings 12 may rotate or turn out so to direct the ultra-high-speed atmospheric airflow such that the vehicle 10 may then rise back out of the atmosphere for a period of time so to cool off the outer skin before it can then resume a controlled descent back to the ground. One might call such maneuver a “controlled skip.” Vehicle's 10 speed should be well below orbiting velocity by such a time. Thus the skip would not be one to lose the vehicle to space.

Thus it is seen that an aerodynamic space vehicle 10 can be made to endure the high heat loads of atmospheric re-entry without need for expensive and/or delicate, high-maintenance prior art heat shielding or wing pivoting. Intumescent paint such as Chartec can provide backup heat resistance. Also, a suitable heat-protecting coating may be placed upon vehicle 10 structure. Such precautions can make the controlled skip either completely unnecessary or allow it to take place deeper into the atmosphere and far from an atmospheric skip-out.

In the back of the vehicle 10 shown in FIG. 1, an engine 25 is provided. Obviously engine 25 would preferably be a rocket with its oxidizer and propellant 20 suitably and preferably stored in at least one tank 30 underneath cabin 28, FIG. 1. However, there may be a dual engine 25 for the additional purposes of powering the landing. In a two-part vehicle, the air breathing engine 25′ of the air vehicle 10 can be used to power the landing. Canceling the need for a dead stick landing can be a plus in a commercial space situation. The second engine 25′ (FIG. 1) could be an air-powered version of U.S. Pat. No. 6,779,334 issued to the instant inventor. Air tanks 30′ (FIG. 5) can then be filled before launch or left empty. If filled, the air can power the engine as an electricity generator and/or power science experiments or the like during flight. Assuming empty air tanks 30′ during reentry, air can be compressed via and during reentry by the nature of reentry. Neither compressors nor their weight need be provided for this vehicle 10. Yet, the added safety margin of powered go-around capability is not only valuable for safety reasons, but it makes many more airports available to the space launcher stack. This is commercially desirable.

FIG. 3 shows that the carrier 50 vehicle can also be powered by a version 25′ of the instant inventor's U.S. Pat. No. 6,779,334. (It, like vehicle 10, can also be powered by a turbojet, turboshaft or fanjet engine 25′. Or as desired.) It is shown with a forward vehicle 10 storage area 45. Vehicle 10 is bolted down to carrier 50 using known explosive bolts preferably. Other hold-down versions can be, for instance, pivoted hold-down clamps that release and move back on their pivots to let vehicle 10 fly away. When released, vehicle 10 lights its rocket 25 and takes off for space. Carrier 50 then flies back to its home port and lands. It can further be fitted with, for example, a short-chord, ducted, blown channel wing 90 (FIG. 1) for high lift. The channel wing 90 can be mounted on winged pylons having lifting airfoils for lift enhancement while simultaneously providing power.

Note that should vehicle 10 be a two-piece vehicle 10, the atmospheric vehicle 10 can be flown to vehicle 50 whereupon it can then pick up its own stored second piece containing its own set of rocket engine 25 and rocket fuel 20 tanks 30. Or it may simply rent not only the second piece but also time on vehicle 50 as well. Naturally all these parts may be owned either by multiple owners or by one owner, privately or commercially. This is preferably not a government operation.

Note that on-board fuel tank 30 of the space vehicle 10 in FIG. 5 may be fitted with known typical bladders 35 (FIG. 5) and especially the known self-sealing variety that collapse as the liquid fuel it contains gets used up. Understand, that the oxidizer tank can be handled the same way as is shown in the description of the fuel tank 30. Obviously, should the rocket 25 be a hybrid solid/liquid variety, it will probably not need one or the other of an oxidizer tank or a fuel tank 30. The liquid, in being sprayed upon the solid fuel 20, lights it up. That is whichever liquid/solid combination is chosen.

The collapse of the bladder 35 then leaves plenty of space for compressed air to be pumped into the emptying fuel tank(s) 30. Thus by using a liquid fuel rocket 25 or a hybrid solid/liquid rocket 25 with bladder tanks 30, compressed air, as for example, can be placed into the otherwise useless empty tank 30, say in area 30′, and used to power the vehicle in space. Obviously the exhausting air from air engine 25′ must be directed to produce a net zero momentum in space. But the exhaust may also be directed as clean thruster exhaust. And it may be used dually to maintain orbit.

Air fluid engine 25′ placed upon a space station may be refilled via on-orbit transfer from vehicle 10 air tank 30′ to a similar air tank 30′ on the space station. Or it may use a swap-out of air tanks 30′. Thus, the lifting of heavy fuel—and corrosive, poisonous fuel at that—is obviated. This makes operating a space station cheaper. Air will not corrode space station systems. They will last longer. And the instant inventor's air engine on Mars will NEVER need to be “refilled.” Thus operating both vehicles and habitats on Mars—or even the Moon—is made simpler, cheaper and much more useful than the prior art. Mars air drills can then be used to drill for water and exploratory missions as well.

Further, the air “exhaust” from an on-orbit air engine 25′ can be recycled into a low-pressure tank (not shown) and then suitably re-pressurized into the station's air tank 30′. “Exhaust” air will be cold, even very cold from expansion. It can be directed to travel through the electronics to cool them before being re-pressurized into air tank 30′. Thruster fuel need never run down and may be cheaply replenished from the ground. The same may be said for a Mars setup. On Mars, air-powered thrusters may be used to hop robots through the atmosphere from place to interesting place. This is a faster way to explore Mars than crawling robots along the ground. Also this may be the best way to move astronaut explorers around on the surface any great distance as well.

Bladder 35 may be obviated by simply using the pressure of the incoming airflow into tank 30 to force.the fuel out. That would save some space for additional air inside tank 30 and also save some weight. Fuel contamination of air from tank 30 that may be directed into thruster bells may occur. But bladder 35 can additionally be used in maintaining air pressurization inside tank 30. This will be shown later.

Minimal weight means maximal payload and safety for the passengers.

It is seen that no extra weight is needed for a separate compressed air tank 30′ which is not needed especially when this bladder configuration is chosen. Thrusters may each be fitted with a small air tank 30′ that can be filled and compressed as engine 25 operates. Thruster operation can thus be air controlled or dually controlled via air 30′ and thruster propellant 30 tanks. But separate air 30′ and fuel 30 tanks are not necessary if contents are separated by bladder 35.

Compressed air would enter the main fuel tank 30, turning it into air tank 30′ as fuel 20 gets used up, via the forward motion of space vehicle 10 as it climbs through the atmosphere under rocket power. See FIGS. 5 and 5A, 5B, and 5C. So that the air does not uncompress as more fuel is used up in the higher, thinner reaches of atmosphere and in space itself, calculations can determine when maximum compression occurs and a known prior art valve may close or another, air, bladder can be fitted with a maximum expansion that maintains maximum compression until air engine 25′ begins to use it. The air bladder 35 may be mechanically drawn in via a known ratcheting mechanism 40 to maintain high air pressure for efficient operation of air engine 25′.

Note that “ullage” may be maintained by the air pressure of the instant configuration. Tank 30′ may be charged with pressurized air by equipment onboard carrier 50. An air bladder 35 must be capable of allowing tank 30′ to be completely filled during re-entry. Go around capability depends upon it.

Fuel/air tank 30 may be preferably made of carbon composite for strength not only to hold fuel, but also for safe, lightweight containment of high pressure air.

As seen in FIG. 5, fuel-containment bladder 35 has an exemplary known ratcheting mechanism 40. Mechanism 40 keeps the bladder 35 tight against the air pressure in tank 30′. It ratchets outward in response to air pressure increase of more than a certain amount so that more air may be added to tank 30′ as vehicle 10 flies. In the preferred embodiment, bladder 35 is permanently attached all along opposite tank 30 corners. This allows for maximum expansion of interior space from an all-fuel tank 30 to an all-air tank 30′. This is done simply by relaxing bladder 35 ratcheting mechanism 40 as it moves from one corner, FIG. 5A, to the middle, FIG. 5B, and then to its opposite corner, FIG. 5C. This allows all propellant 20 to be loaded into tank 30. As vehicle 10 flies, then in response to exiting propellant 20 and incoming air pressure, preferably directly from flight, the ratcheting mechanism 40 relaxes and bladder 35 then travels behind propellant 20 to make room in the now-tank-30′ for the exemplary compressed air. At the hypotenuse, ratcheting mechanism 40 relaxes again so to pay out bladder 35 as tank 30′ fills to the other corner. If a full air tank 30′ results, the bladder 35 will wind up in the opposite corner from the one it started with when propellant 20 was aboard, see FIG. 5C.

As air is used up, air pressure within tank 30′ lessens. As pressure lessens, ratchet 40 closes down in response to the dropping pressure so to keep the air pressure constant between bladder 35 and the tank 30′ walls. Thus even with air being used up, the remaining air within bladder 35 is still compressed thanks to the combination of bladder 35 and ratchet 40.

Instead of ratchet 40, a known simple electric motor powered wire 42 can be used to pull bladder 35 towards the air tank 30′ corner (As in FIG. 5A) so to keep air pressure high as air leaves tank 30′ and goes to engine 25′. This type of mechanical movement has been demonstrated on Mars as the mechanism that brought the used airbags under the landed spacecraft wings to allow rovers to roll off.

When bladder 35 reaches a diagonal position midway between the corners while being ratcheted, FIG. 5B, it stops. This is true by physics laws so long as no propellant 20 is being loaded on its other side. The pressure of fueling incoming liquid propellant 20 causes ratchet 40 to release and allow bladder 35 to move into its starting corner, FIG. 5A. This once again completely fills tank 30 with fuel.

Ratchet 40 by either rolling up or letting out bladder 35 is used to keep air pressure constant and compressed as much as possible. Midway, it stands fast so to maintain a solid bladder 35 wall for the air pressure to act upon.

At the diagonal position of bladder 35, air pressure within tank 30′ then begins to decrease with each use. Engine 25′ will continue to work until air pressure falls to a very low state. At that point on-board batteries or fuel cells, or the end of the mission, comes to fore. This situation is obviated with the use of wire 42 to pull bladder 35 towards the air tank 30′ corner. Then, useful air pressure can be maintained for a longer period of time.

Rocket propellant 20 will preferably always be encased within a full self-sealing bladder 35. By pinning bladder 35 to opposite corners of tank 30, bladder 35 can then move from one corner to the remaining corner in response to the drop in propellant 20 and the preferred speed-forced rise in air pressure within air tank 35′.

Bladder 35 prevents fuel 20 contamination of pressurized air that may be used in thrusters upon re-entry.

So initial air pressurization during the climbing stage of takeoff within the atmosphere should and could drive enough air into air tank 30′ to allow air engine 25′ to do much in-space work! Then during reentry, tank 30′ will be re-pressurized by the force of high-speed descent. Hence, engine 25′ can then be used for powered descent and landing go-around capability.

Not only that, but in high-speed descent the entire air system may be opened at each thruster so that poisonous remnant fuel is forced out by hot, high-pressure air well in the upper atmosphere and far away from the ground. When closed, all thrusters will operate on air alone into the atmosphere where aircraft flight control surfaces then take over control of the vehicle 10. But the vehicle 10 will have been fully “safed” high in the upper atmosphere.

Should engine 25′ be an air-powered turbine or APU generating electricity, the electrical power can then be used to turn propellers or fans of electric engine 25′. This configuration can be used in space flight to operate electrical on-board equipment during flight.

Note that air engine 25′ can be fitted with well-known aviation magnetos (not shown) so to generate electrical current as magnetos always do. The electrical current can then be used to power an on-board air compressor 55. By adding at least one compressor 55, air tank 30′ can be re-pressurized while engine 25′ is working. In so doing, descending vehicle 10 can have multiple go around landing capability plus increased sideways range of travel. Powered travel to alternate airports due to bad weather (usually) or other unsafe conditions is another earmark of the instant invention 10 that does NOT appear in the prior art. This is a further additional safety factor for the instant vehicle 10. Such adding safety factors make this vehicle combination 10+50 design a far safer space and launch vehicle combination 10+50 than prior art.

Multiple go-around capability may be effected via on-board gas generators that feed air engine 25′.

It should be noted that in order to save even more fuel, space and weight on space vehicle 10, carrier 50 may instead be transformed into a balloon carrier 50. Balloon carrier 50 is capable of carrying space vehicle 10 to far higher altitudes than powered carrier 50. Thus, vehicle 10 may be made even smaller and lighter than ever. Although the balloon 50 is not shown, weather balloons, existing and newly-designed but known around-the-world balloon designs and other patentable types of balloons could be used. These would be described elsewhere in the art. And so would not be described here.

In space, normal prior art thrusters use poisonous chemicals. In the instant invention 10, instant air engine 25′ can direct cleansing air through the thruster ports to purge them of toxic remnants during reentry. This could happen high in the atmosphere. Thus the vehicle will be “safed” in flight and ready to be immediately approached by normal people on the ground without wearing hazmat protection. This then makes returning vehicle 10 safe for normal landing at normal airports. Again, such is not possible in prior art space vehicle designs.

Alternatively, and/or in addition, plumbing from tank 30′ and/or air engine 25′ can direct its air exhaust through thruster ports to impart a spatial correction of vehicle 10 instead of using the toxic propellants. Thruster propellants would be held as backups in case the air pressure in tank 30′ falls low enough to not empower engine 25′ in space. Small associated thruster air tanks 30′ could be useful in the application where air powered thrusters are used during re-entry to purge the thrusters and “safe” them in the upper atmosphere. Such an air thruster system, preferably entirely connected together, can be pressurized during ascent while still in the atmosphere or the thruster system may either be pressurized on the ground, or during flight by equipment carried aboard carrier 50. Such equipment (not shown) may also be used to pressurize dedicated air tanks 30′ in flight before release of vehicle 10 by vehicle 50 so to bring a plethora of renewal air to a space station or to an interplanetary type vehicle (not shown).

Note that as far as direct air plumbing goes, ultra-hot air from descent directly passing into a full connected plumbing system that exits out through the thruster system all at one time can truly purge the toxic chemicals out of the thrusters while maintaining balanced maneuvering forces. Then such air from lower and slower in the atmosphere can be captured in thruster air tanks and reserved for go-around capability.

And as far as “renewal” air goes, the “exhaust” of air engine 25′ may be directed into the crew quarters for oxygen maintenance. Such exhaust may also be collected into a low-pressure dedicated “exhaust” tank (not shown) and then re-pressurized again in tank 30′ for recycling into air engine 25′ again. This would be useful on Mars. It minimizes the amount of air needed. And on Mars it minimizes the amount of new, thin atmospheric air needed to replace used compressed high pressure working air. As said earlier, cold exhaust air before being recycled can also cool equipment thus obviating separate equipment cooling means including cooling energy generation. And recycling closes the system allowing further weight and costs savings.

FIG. 4 shows an inflatable balloon-like structure 70 that has refractory materials on its face 71 (at least) inflated for the purpose of slowing down a very high-speed vehicle 10; say from orbital velocity or higher. This type of inflatable 70 can be made of Airmat, which was already designed by Goodyear Aerospace, its original developer, to act as inflatable fins for rockets. So it is known to be able to handle rocket forces. It has done so in blow-down tubes. Plus intumescent paint or heat-resistant coatings upon face 71 may simplify the heat shielding problem. It may also obviate the need for carbon-carbon, expensive heat resistant structure.

Note that intumescent paint or coatings may also coat wings 12 and 14.

Also, Airmat may protect engine bell 25 and engine 25′ during re-entry and then deflate to allow ambient atmospheric air to get to engine 25′ for powering the final landing phase of vehicle 10.

After use in the upper atmosphere, the structure 70 can be reeled back up and away from the pilot's eyes for enabling vision in the lower atmosphere. Note that because the carrier 50 pilot is the only pilot needing to see for takeoff, structure 70 may be set in place on the ground and then reeled in during space flight or re-entry as necessary. Structure 70 may be slidably attached to ties 85 and move up and down the spacecraft 10 via suitable well known actuators. Space vehicle 10 pilot would probably need to see to dock at a space station or with an interplanetary “mother” ship. Thus, structure 70 would probably never cover the vision of the pilot of vehicle 10 until just as it is ready for re-entry. Before re-entry, pressurized air may be blown into structure 70 to allow it to fully cover vehicle 10 again. Or it may be moved or slid into working position using known actuators.

Thus, all the above-recited novel pieces can be put together into one novel space launcher 10+50 that can find acceptance at local airports due to its safe, powered fly back ability. Taking off as an airplane lessens any objections to operating it from a typical commercial airport instead of a far-off, hard-to-get-to space port. Plus in-flight thruster safing via air thrusters while in the upper atmosphere ends the last objection to a space plane coming into a commercial airport. And a large balloon carrier vehicle 50 for carrying vehicle 10 up to 100,000 feet of altitude or thereabouts would not necessarily cause concern for commercial airports either.

FIG. 6 shows multiple thin wings 12 in cross section. Thin, of any chord, wings 12 are best for high speed flight. By grouping thin wings 12, high lift for slow speed flight can be induced when wings 12 are moved into position, see the grouping to the right of FIG. 6. Also, grouping positioning can form ram blowing of thin wings 12 to increase lift in high speed flight. See the single arrow showing airflow between wings on the left side of FIG. 6. Additionally, short chord wings 12 can be used to maintain center of pressure control throughout the entire flight envelope. Thus, for many reasons, the instant invention 10 prefers the use of multiple wings.

IN OPERATION, a space launch carrier vehicle 50 is loaded with a space vehicle 10. The stack 50+10 takes off under the power of the carrier 50. This power may be the power of balloon floatation. In the instant configuration, the space vehicle 10 can lift its own weight via its own wings. Thus the entire stack 50+10 is smaller and more lightweight, hence costs less than prior art designs.

At altitude, the carrier lets go of the space vehicle, preferably via explosive bolts. As the space vehicle falls, or flies away using its wings, it starts its rocket 25 and proceeds up to space. Along the way, it can pressurize an air canister 30′. In orbit or after the rocket shuts off and while in ballistic trajectory flight, the pressurized air in air tank 30′ can then operate a fluid engine 25′ to maintain onboard operations and perform tasks.

During reentry of the space vehicle 10, thrusters—which may be powered by the compressed onboard air—align the space vehicle 10, 90-degrees to the direction of travel. The space vehicle 10 preferably has multiple wings 12 that can be used either for low speed flight or high. The wings 12 can have Magnus rotors on them to increase their lift. The space vehicle's multiple wings 12 also form a massive drag producing planform that slows the craft down without need for a heat shield. The multiple wings can individually be turned out as desired to raise the vehicle 10 trajectory in flight and perform a “controlled skip” maneuver so to reduce heat buildup as vehicle 10 comes back from orbit or farther out. During descent through the atmosphere, the high speed flight can re-pressurize the compressed air canister 30′ and make it ready to feed fluid engine 25′ so to power the final moments of landing and allow multiple landing attempts as may be necessary. This increases safety and allows the use of many more airports than merely one far-away dedicated spaceport. Additionally, the pressurized air can be forced through the thruster ports to “safe” them while high above the ground. Thus the craft 10 lands as a safe airplane.

It should be emphasized that the above-described embodiments of the present invention, particularly, any “preferred” embodiments, are merely possible examples of implementations, merely set forth for a clear understanding of the principles of the invention. The overall Spirit of the instant invention in not only its disclosed form but also in all other conceivable embodiments thereof, is what I seek to protect. Many variations and modifications may be made to the above-described embodiment(s) of the invention without departing substantially from the spirit, scope and principles of the invention. All such modifications and variations are intended to be included herein within the scope of this disclosure and the present invention and protected by the following claims.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

I claim:

1. A low-cost space launcher, comprising:
An air vehicle;
Said air vehicle transforming into a space vehicle by;
Said space vehicle adapted to releasably hook onto rocket pods;
Said rocket pods having optional fuel tanks attached thereto; and
Said space vehicle and rocket pods together adapted to hook onto a launcher vehicle.

2. The low-cost space launcher of claim 1 wherein said air vehicle transforming into a space vehicle has a multitude of wings, said multitude of wings adapted to provide protection of heat of re-entry and optionally have Magnus rotors for increasing lift.

3. The low-cost space launcher of claim 1 wherein said launcher has fuel tanks that are capable of storing compressed air in the space vacated by fuel used in the process of propulsion.

4. The low-cost space launcher of claim 3 wherein said compressed air is used in at least one of an air-fueled engine, and thrusters, and cooling, and recycling, and refueling.

5. The low-cost space launcher of claim 1 wherein said vehicle is at least one of fully privately owned, partially rented, fully rented.

6. The low-cost space launcher of claim 1 wherein said rocket pods are at least one of liquid fueled, hybrid fueled, solid fueled.

7. The low-cost space launcher of claim 1 wherein said launcher vehicle is engine driven and optionally is balloon powered.

8. A low-cost space launcher, comprising:
Air flying vehicle;
Said air flying vehicle having engine mountings;
Said engine mountings holding at least one of rocket engines and air-breathing engines;
Said vehicle and engines adapted to be carried into upper atmosphere by a carrier vehicle; and
Said vehicle, engines and carrier vehicle together adapted to fly from home to space.

9. The low-cost space launcher of claim 8 wherein said air flying vehicle has a plurality of wings, said wings capable of forming a heat shield and drag for atmospheric re-entry.

10. The low-cost space launcher of claim 9 wherein said wings are at least one of short chord, variable sweep, telescoping, foldable, capable of directing airflow and provided with Magnus rotors.

11. The low-cost space launcher of claim 8 wherein said air breathing engine can operate as at least one of propulsor, thruster, cooler, hybrid thruster and go-around propulsion.

12. The low-cost space launcher of claim 8 wherein said vehicle has fuel tanks that can be adapted to alternately hold fuel and air in the same space.

13. The low-cost space launcher of claim 8 wherein said carrier vehicle can be at least one of engine powered and balloon powered.

14. A method of making a space launcher, comprising:
Making an air vehicle;
Making said air vehicle adaptable to carrying rocket pods; and
Adapting said air vehicle and rocket pods to be carried aloft by a carrier vehicle.

15. The method of claim 14 wherein said air vehicle is adapted to at least one of flying car, low speed flight, high speed flight, transitioning flight and space flight.

16. The method of claim 14 wherein said air vehicle has at least one of air-breathing engines and rocket engines.

17. The method of claim 14 wherein said engines are provided to do at least one of powering said vehicle, provide thrusting in space of said vehicle, cooling said vehicle and providing go-around landing capability for said vehicle.

18. The method of claim 14 wherein said carrier vehicle is powered by at least one of air-breathing engines, piston engines, jet engines and rocket engines.

19. The method of claim 14 wherein said vehicle is provided with wings that can also provide heat shielding and re-entry directional control.

20. The method of claim 14 wherein said vehicle is provided as at least one of a rental, an owned vehicle and a partial rental and partially owned vehicle.
